(19) United States
(12) Patent Application Publication
(10) Pub. No.: US 2003/0007628 A1
(43) Pub. Date: Jan. 9, 2003

(54) Load balancing among call center agents

(75) Inventors: Pnina Vortman, Haifa (IL); Irena Notkin, Haifa (IL); Boris Bachelis, Haifa (IL)

Correspondence Address: BROWDY AND NEIMARK, P.L.L.C., 624 NINTH STREET, NW, SUITE 300, WASHINGTON, DC, 20001-5303, US

(73) Assignee: INTERNATIONAL BUSINESS MACHINES CORPORATION

(21) Appl. No.: 09/888,443

(22) Filed: Jun. 26, 2001

(51) Int. Cl. H04M 3/00; H04M 5/00

(52) U.S. Cl. 379/266.07

(57) ABSTRACT

A method for handling a customer contact request over a communication network includes selecting a subset of the agents at random within a set of agents who are able to handle the request. Relative levels of workload are determined among the agents in the subset, and one of the agents in the subset to whom to assign the request is chosen so as to balance the relative levels of workload within the subset.

### FIELD OF THE INVENTION

The present invention relates generally to customer relationship management, and specifically to allocation of customer contact requests among customer service agents.

### BACKGROUND OF THE INVENTION

In the growing area of customer care and electronic business, contact centers play a crucial role. Business uses contact centers—also referred to as call centers—to provide their customers with efficient access to a wide base of information, knowledge and assistance over the telephone and other communication networks. Call centers were originally developed to deal with customer telephone inquiries. In recent years, however, call centers have grown into contact centers, designed to handle not only voice calls over the telephone network, but also various digital communication channels, such as e-mail, packetized voice and Web access. At the same time, the growth in electronic commerce has driven a concomitant growth in the number and types of inquiries to which a contact center must respond and, accordingly, in the personnel base that a contact center must maintain.

The result of these growth trends is that contact centers must employ ever larger numbers of agents in order to reply to customer inquiries in real time. Some of these “agents” may be automated elements, functioning autonomously without a human operator. For the most part, however, the agents are human beings, who are grouped in the contact center according to their knowledge and ability to handle customer needs of a given type. An Automatic Call Distribution (ACD) switch in the contact center is typically responsible for determining the type of assistance a particular customer requires, and then routing the customer's contact request to an agent in the appropriate group. It is also important that the ACD balance the load of calls among the agents in the group, so that work is fairly distributed and the available resources are used as efficiently as possible. ACD may be implemented using either dedicated hardware or a combination of hardware and software elements (sometimes referred to as a “soft ACD”) . Therefore, the terms “ACD” and “ACD switch” as used herein should be understood to include both hardware and software solutions unless specified otherwise.

Methods for load balancing among agents in a call center are known in the art. An exemplary method and system of this type are described in U.S. Pat. No. 4,949,373, whose disclosure is incorporated herein by reference. A pilot telephone number is provided to act as the entry point to all the agents associated with a particular marketing area. The pilot number is linked to each of the available agents capable of servicing a particular type of call. ACD load balancing maintains queue counts on pilot groups that are to be balanced together. A load balancing algorithm determines where callers should be transferred by monitoring the number of calls in each pilot group and comparing this number to the current queue level parameters and the number of calls in other pilot group queues. The algorithm used to balance the load among the agents within a given group is not specified in the patent.

The load balancing algorithm described in U.S. Pat. No. 4,949,373, like other methods of load balancing known in the art, is dependent on continual tracking and updating of the loads on every pilot group or every agent within the group. Whenever a new call is received, the load statistics of all of the pilot groups or of all of the agents in a group must be scanned, so that the call can be assigned to the least-loaded group or agent. In this manner, the workload is distributed optimally among all of the agents. As long as the number of agents is not too big, this optimal distribution method is easy to manage. In large organizations, however, with large numbers of agents and many incoming calls, the computational burden of optimal load balancing becomes substantial.

### SUMMARY OF THE INVENTION

Preferred embodiments of the present invention provide a sub-optimal method for load balancing in a contact center, geared toward quick selection and assignment of agents to handle customer contact requests. For each request coming in, a small set of agents is chosen at random among the agents who are qualified and ready to handle the request. The request is then assigned to the least heavily-loaded agent in the chosen sample. The load on agents outside the chosen set is ignored.

Although this technique may cause small, transient imbalances in load distribution, it balances the load among the agents over the long run nearly as well as do “optimal” solutions. The present technique, however, incurs far smaller computational cost than do optimal solutions, which must consider all agents in every call assignment that they make. The inventors have found that choosing random sets as small as two agents for each request still gives adequate results. The technique may be implemented both in hardware-based ACD switches and in software-based solutions for distributing customer requests. It is useful not only for handling voice requests, but also in distributing contact requests of other types, such as e-mail and Web-based requests. Although preferred embodiments are described herein with reference to load distribution among human agents, the techniques described herein are also applicable to automated agents, and the term “agent” as used herein should therefore be understood broadly. In addition, the principles of the present invention may also be applied in other load balancing applications, as are encountered, for example, in communication networks and computing clusters.

There is therefore provided, in accordance with a preferred embodiment of the present invention, a method for handling a customer contact request over a communication network, including:

within a set of agents who are able to handle the request, selecting a subset of the agents at random;

determining relative levels of workload among the agents in the subset; and

choosing one of the agents in the subset to whom to assign the request so as to balance the relative levels of workload within the subset.

Preferably, choosing the one of the agents includes choosing the agent substantially without regard to the workload of the agents in the set outside the subset. Further preferably, choosing the one of the agents includes assigning the request to the agent in the subset whose level of workload is minimal within the subset. Most preferably, assigning the request includes tracking a number of customer requests handled by each of the agents over a period of time, and assigning the request to the agent who has handled the smallest number of the requests among the agents in the subset. Additionally or alternatively, selecting the subset of the agents includes determining a skill profile needed to handle the call, and defining the set of the agents responsive to the skill profile.

In a preferred embodiment, selecting the subset includes selecting less than 10% of the agents in the set for inclusion in the subset.

Typically, choosing the one of the agents includes routing a telephone call from the customer to the agent or, alternatively or additionally, routing a data packet received over a digital data network from the customer to the agent.

There is also provided, in accordance with a preferred embodiment of the present invention, apparatus for handling a customer contact request over a communication network, including a dispatcher, arranged to select at random, within a set of agents who are able to handle the request, a subset of the agents, to determine relative levels of workload among the agents in the subset, and to choose one of the agents in the subset to whom to assign the request so as to balance the relative levels of workload within the subset.

Preferably, the apparatus includes a request analyzer, which is arranged to determine a skill profile needed to handle the call, wherein the set of the agents who are able to handle the request is defined responsive to the skill profile.

Further preferably, the apparatus includes a router, coupled to route a telephone call from the customer to the chosen agent or, additionally or alternatively, to route a data packet received over a digital data network from the customer to the chosen agent.

There is additionally provided, in accordance with a preferred embodiment of the present invention, a computer software product for handling a customer contact request over a communication network, the product including a computer-readable medium in which program instructions are stored, which instructions, when read by a computer, cause the computer to select at random, within a set of agents who are able to handle the request, a subset of the agents, to determine relative levels of workload among the agents in the subset, and to choose one of the agents in the subset to whom to assign the request so as to balance the relative levels of workload within the subset.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a contact center, in accordance with a preferred embodiment of the present invention;

FIG. 2 is a block diagram that schematically illustrates an automatic contact distributor, in accordance with a preferred embodiment of the present invention;

FIG. 3 is a flow chart that schematically illustrates a method for distributing customer requests among agents, in accordance with a preferred embodiment of the present invention; and

FIGS. 4-6 are data plots that schematically illustrate levels of imbalance in distribution of customer requests over time among agents in a contact center, in accordance with a preferred embodiment of the present invention.

### DETAILED DESCRIPTION OF PREFERRED EMBODIMENTS

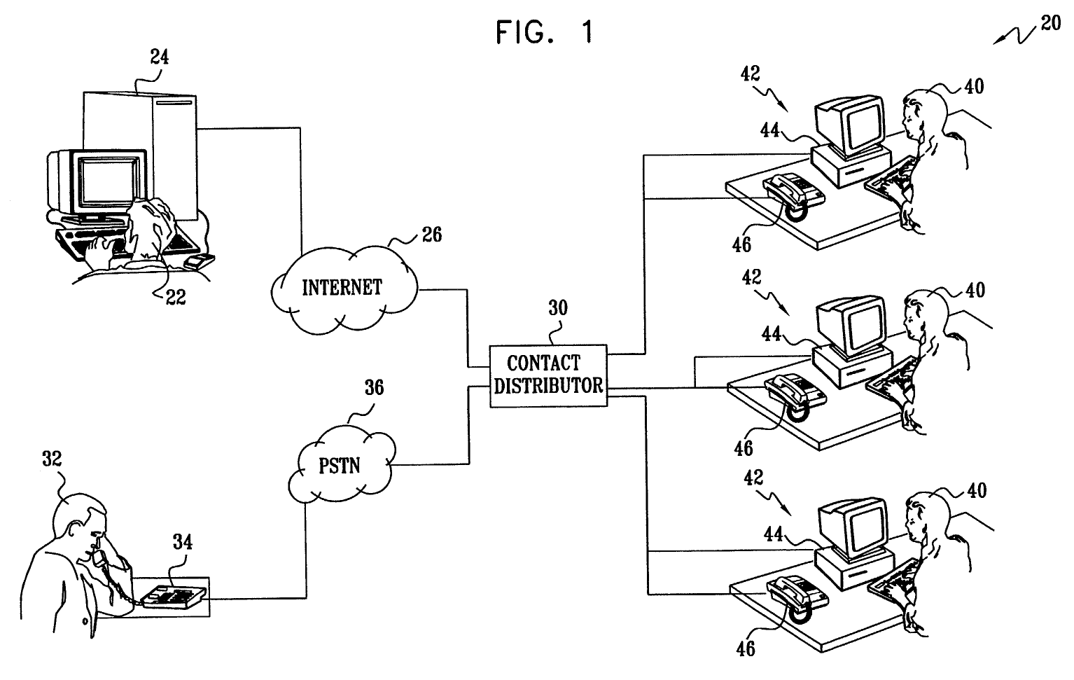

FIG. 1 is a block diagram that schematically illustrates a contact center 20, in accordance with a preferred embodiment of the present invention. Contact center 20 might also be referred to as a call center, except that, for the sake of generality, it is configured to receive not only voice requests, but also requests via digital communication channels. Thus, in the illustrated embodiment, a customer 22 uses his computer 24 to access contact center 20 via a packet network 26, such as the Internet. The access may be in substantially any form, such as an e-mail message, entry of data via a Web site, a Web chat request or a voice over Internet Protocol (VoIP) call. Alternatively or additionally, another customer 32 accesses contact center 20 using a telephone 34 via a public switched telephone network (PSTN) 36, as in conventional call centers.

Customer requests addressed to center 20 are handled by an automatic contact distribution switch 30. In a call center, switch 30 would operate as an automatic call distribution (ACD) switch, which may be hardware- or software-based, as described in the Background of the Invention. The function of switch 30 is to distribute customer contact requests among multiple agents 40. Typically, each agent has a workstation 42, equipped with a computer terminal 44 and a telephone 46. When switch 30 decides to route a given customer request to one of the agents, information concerning the request (and possibly the request itself, in the case of an e-mail or Web-based request) appears on terminal 44, while voice calls are passed to telephone 46. Given a suitable software implementation of switch 30, agents 40 and their workstations 42 may be widely distributed, and may even be located in different geographical areas, linked via local- and/or wide-area data and voice networks to switch 30.

Switch 30 is responsible, inter alia, for load balancing among agents 40 using a novel, sub-optimal scheme that is described hereinbelow. Preferably, the switch comprises one or more microprocessors, which carry out the load-balancing functions of the switch under software control. This software may be downloaded to the switch in electronic form, or it may be furnished on tangible media, such as CD-ROM or non-volatile memory, for installation in the switch. Alternatively or additionally, certain functions of the switch may be carried out by a dedicated processor or hard-wired logic.

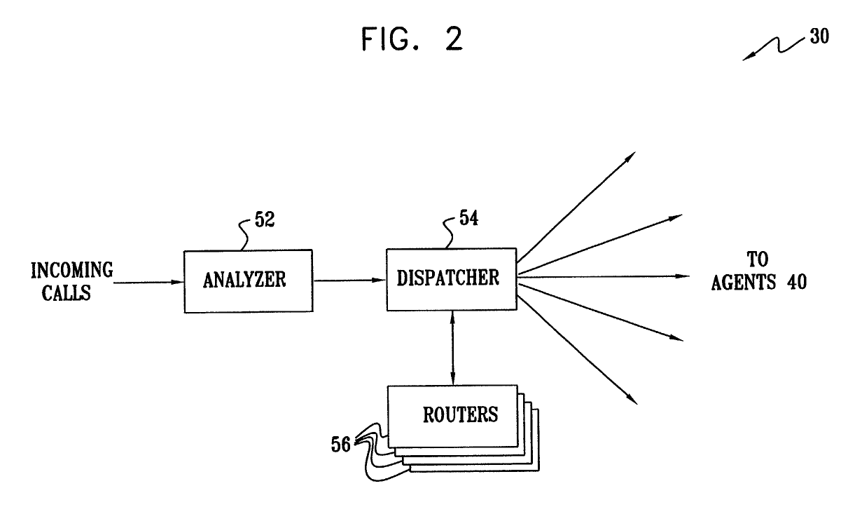

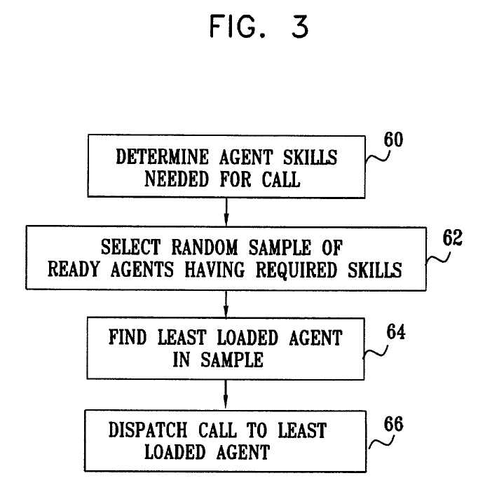

FIG. 2 is a block diagram that schematically illustrates details of contact distribution switch 30, in accordance with a preferred embodiment of the present invention. Incoming calls and other customer requests reaching contact center 20 are first analyzed by a call analyzer 52, in order to determine the agent skills required to handle each request. Based on the determined skills, a dispatcher 54 refers the call to one or more routers 56, in order to decide which of agents 40 is to be assigned to handle the customer request. The routers take into account factors such as the skills of agents 40 and load balancing considerations. The method for making the routing decision is described in detail with reference to FIG. 3. Based on input from routers 56, dispatcher 54 passes the request to the selected agent.

FIG. 3 is a flow chart that schematically illustrates a method for assigning customer contact requests to agents 40, in accordance with a preferred embodiment of the present invention. The method is described here with reference to a call from a customer, but is equally applicable to contact requests of other types. Upon receiving the call, analyzer 52 determines which skill group within the total body of agents 40 is qualified to handle the customer request, at a skill determination step 60. The skill group is preferably determined based on customer responses to an automated interactive voice response (IVR) system that screens incoming calls. Alternatively, the skill group may be determined in substantially any other suitable way, typically using other methods of automated interaction and analysis, or even manual assignment by a telephone receptionist.

Dispatcher 54 is notified by analyzer 52 of the skill group from which the agent is to be assigned for the current call. The dispatcher scans a list of the agents in this group who are ready to take the call, i.e., the agents who are not busy or unavailable to take the call for some other reason. From this list, the dispatcher chooses at random a predetermined subset of the ready agents, at a sample selection step 62. Typically, for the sake of computational efficiency, the subset comprises between two and four agents, although larger subsets may also be used.

Dispatcher 54 checks the load statistics of the agents in the selected subset, at a load checking step 64. The load statistics give a load level for each agent, which preferably represents the number of calls that each of the agents has handled over a certain reference period, up to the last call that the agent received. Substantially any measure of load can be used, included weighted measures, such as measures that are weighted by the length of the calls that the agent has handled, or that weight recent calls more heavily than earlier ones. The statistics for all of the agents are preferably maintained either by dispatcher 54 itself, or by workstations 42, or by a separate statistics unit (not shown) in switch 30. At a dispatching step 66, the dispatcher passes the call to the agent in the random subset who currently has the lowest load level.

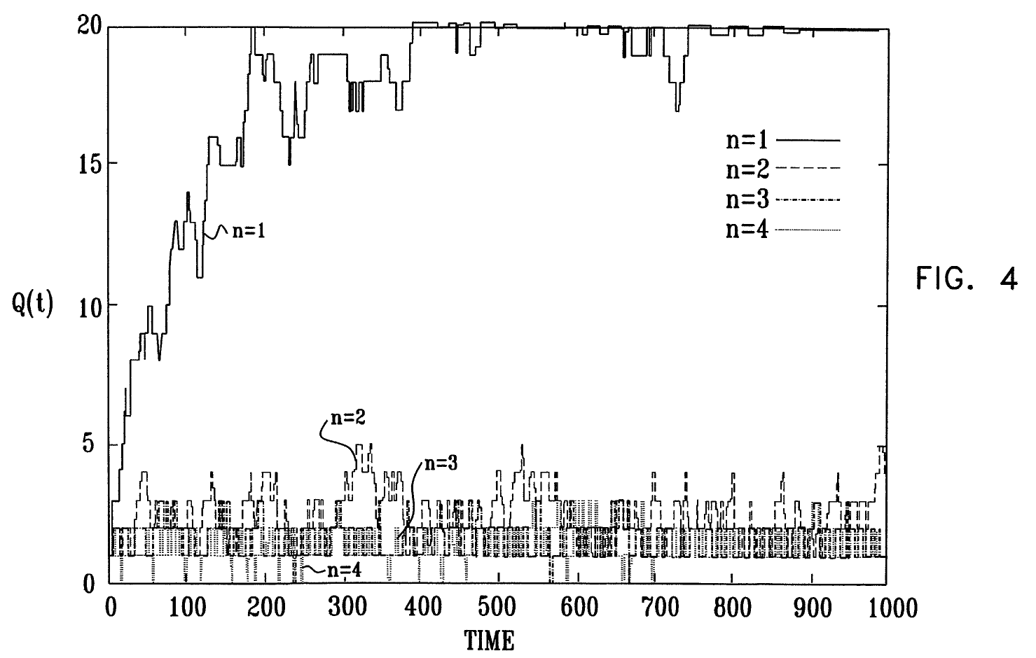

FIGS. 4-6 are plots that schematically illustrate variation of a load-balancing quality factor Q(t) over time, determined in a simulation of the method of FIG. 3, in accordance with a preferred embodiment of the present invention. Let the load level on each agent simply be the number of calls assigned to that agent during a period [0,t]. Q(t) is defined as the difference between the maximum load level and the minimum load level among all of the agents at time t. For an optimal (but computation-intensive) load balancing algorithm, Q(t) will always be equal to either zero or one.

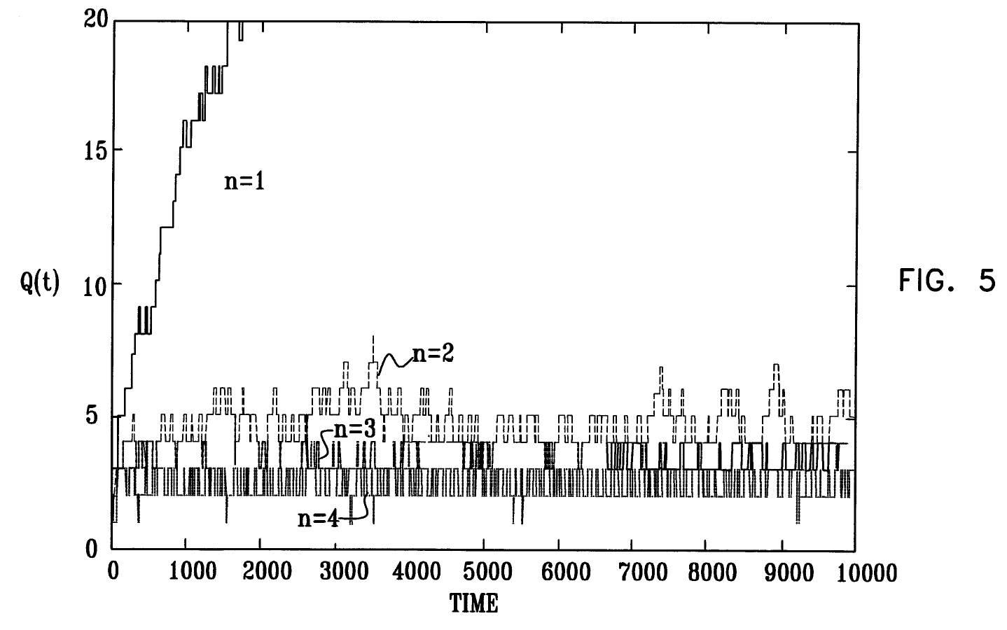

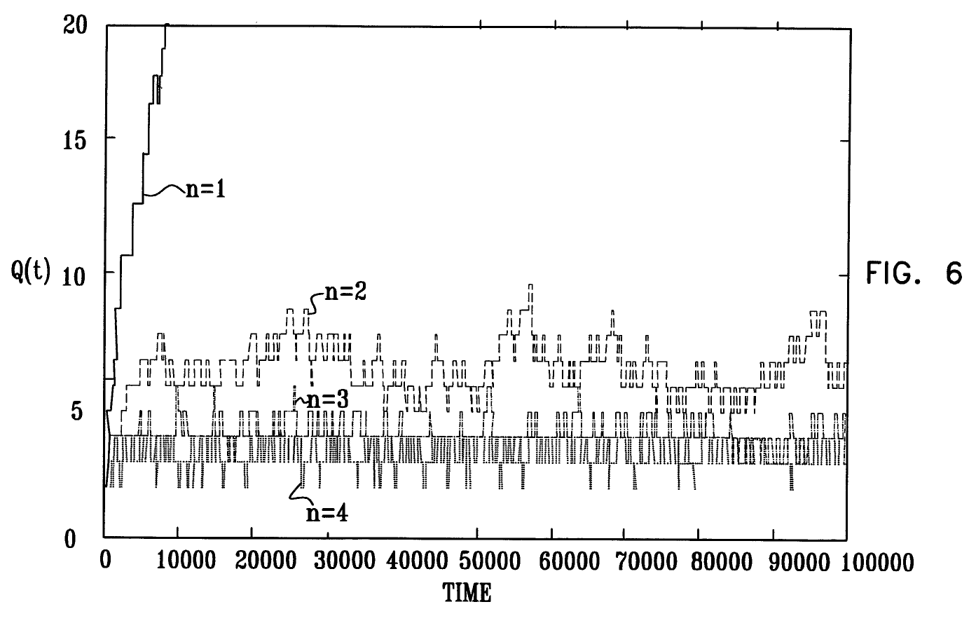

In the sub-optimal algorithms used in preferred embodiments of the present invention, the agent with the lowest load level is chosen from a subset containing n agents, who are selected at random from the entire group of available qualified agents. In the example shown in FIG. 4, there are ten such qualified agents (N=10). FIGS. 5 and 6 show examples with N=100 and N=1000, respectively. At each time tick, a new task is assigned to the agent chosen at that tick. The upper curve in each figure, with n=1, represents simply a random selection of a single agent among all those qualified. In this case, Q(t) is large and continues to grow over time without bound, albeit slowly. It will be observed, however, that for any value of n≧2, Q(t) stabilizes quickly around a mean value that is not much greater than one, with moderate variance.

Table I below summarizes the mean values of Q(t) obtained for a number of different values of N (total number of agents) and n (size of random subset):

TABLE I
LOAD BALANCING QUALITY FACTORS

| | n = 2 | n = 3 | n = 4 |
|---|---|---|---|
| N = 10 | 2.33 | 1.66 | 1.35 |
| N = 100 | 5.13 | 3.05 | 2.37 |
| N = 1000 | 6.58 | 4.09 | 3.30 |

From this table, it is evident, surprisingly, that even over a population of a thousand agents, load balancing over very small, random subsets of the population gives long-term balancing that is not much worse than full, optimal balancing over the entire population. The subset may thus comprise less than 10% of the total population (or even less than 1%) and still give acceptable results.

Although preferred embodiments are described herein with reference to contact center 20, other applications of the principles of the present invention will be apparent to those skilled in the art. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for handling a customer contact request over a communication network, comprising:
within a set of agents who are able to handle the request, selecting a subset of the agents at random;
determining relative levels of workload among the agents in the subset; and
choosing one of the agents in the subset to whom to assign the request so as to balance the relative levels of workload within the subset.

2. A method according to claim 1, wherein choosing the one of the agents comprises choosing the agent substantially without regard to the workload of the agents in the set outside the subset.

3. A method according to claim 1, wherein choosing the one of the agents comprises assigning the request to the agent in the subset whose level of workload is minimal within the subset.

4. A method according to claim 3, wherein assigning the request comprises tracking a number of customer requests handled by each of the agents over a period of time, and assigning the request to the agent who has handled the smallest number of the requests among the agents in the subset.

5. A method according to claim 1, wherein selecting the subset of the agents comprises determining a skill profile needed to handle the call, and defining the set of the agents responsive to the skill profile.

6. A method according to claim 1, wherein selecting the subset comprises selecting less than 10% of the agents in the set for inclusion in the subset.

7. A method according to claim 1, wherein choosing the one of the agents comprises routing a telephone call from the customer to the agent.

8. A method according to claim 1, wherein choosing the one of the agents comprises routing a data packet received over a digital data network from the customer to the agent.

9. Apparatus for handling a customer contact request over a communication network, comprising a dispatcher, arranged to select at random, within a set of agents who are able to handle the request, a subset of the agents, to determine relative levels of workload among the agents in the subset, and to choose one of the agents in the subset to whom to assign the request so as to balance the relative levels of workload within the subset.

10. Apparatus according to claim 9, wherein the dispatcher is arranged to choose the agent substantially without regard to the workload of the agents in the set outside the subset.

11. Apparatus according to claim 9, wherein the dispatcher is arranged to assign the request to the agent in the subset whose level of workload is minimal within the subset.

12. Apparatus according to claim 11, wherein the dispatcher is arranged to determine a number of customer requests handled by each of the agents over a period of time, and to assign the request to the agent who has handled the smallest number of the requests among the agents in the subset.

13. Apparatus according to claim 9, and comprising a request analyzer, which is arranged to determine a skill profile needed to handle the call, wherein the set of the agents who are able to handle the request is defined responsive to the skill profile.

14. Apparatus according to claim 9, wherein the selected subset comprises less than 10% of the agents in the set.

15. Apparatus according to claim 9, and comprising a router, coupled to route a telephone call from the customer to the chosen agent.

16. Apparatus according to claim 9, and comprising a router, coupled to route a data packet received over a digital data network from the customer to the chosen agent.

17. A computer software product for handling a customer contact request over a communication network, the product comprising a computer-readable medium in which program instructions are stored, which instructions, when read by a computer, cause the computer to select at random, within a set of agents who are able to handle the request, a subset of the agents, to determine relative levels of workload among the agents in the subset, and to choose one of the agents in the subset to whom to assign the request so as to balance the relative levels of workload within the subset.

18. A product according to claim 17, wherein the instructions cause the computer to choose the agent substantially without regard to the workload of the agents in the set outside the subset.

19. A product according to claim 17, wherein the instructions cause the computer to assign the request to the agent in the subset whose level of workload is minimal within the subset.

20. A product according to claim 19, wherein the instructions cause the computer to determine a number of customer requests handled by each of the agents over a period of time, and to assign the request to the agent who has handled the smallest number of the requests among the agents in the subset.

21. A product according to claim 17, wherein the instructions cause the computer to determine a skill profile needed to handle the call, and to define the set of the agents responsive to the skill profile.

22. A product according to claim 17, wherein the instructions cause the computer to select the subset so as to comprise less than 10% of the agents in the set.

23. A product according to claim 17, wherein the instructions cause the computer to route a telephone call from the customer to the chosen agent.

24. A product according to claim 17, wherein the instructions cause the computer to route a data packet received over a digital data network from the customer to the chosen agent.
